(19) United States
(12) Patent Application Publication
(10) Pub. No.: US 2013/0347082 A1
(43) Pub. Date: Dec. 26, 2013

(54) Unit-of-Use Control of a Computing Resource

(71) Applicant: Frank J. Ponzio, JR., Mantoloking, NJ (US)

(72) Inventor: Frank J. Ponzio, JR., Mantoloking, NJ (US)

(21) Appl. No.: 13/920,488

(22) Filed: Jun. 18, 2013

Related U.S. Application Data
(60) Provisional application No. 61/662,963, filed on Jun. 22, 2012.

(51) Int. Cl. H04L 29/06

(52) U.S. Cl. CPC H04L 63/10
USPC 726/4

(57) ABSTRACT

A system and method for unit-of-use utilization of a computing resource is described. A user obtains utilization permissions for a computing resource which are recorded in a Unit-of Use (UoU) certificate. These permissions include temporal and/or functional use constraints that are static and/or dynamic. A UoU controller employs these permissions to control access by the user to the computing resource. The unit-of-use controller receives feedback from the computing resource in the form of utilization information regarding actual usage by the user which is recorded in the UoU certificate. The computing resource may include a cloud based service, operable on one or more cloud servers. The computing resource utilization permissions are preferably part of an electronic UoU certificate. This certificate is incorporated into an email, IM or a similar message medium and electronically delivered via communications network, typically from a first, user's device to a second, user's device.

### CLAIM OF PRIORITY

This application is a non-provisional application of U.S. Application Ser. No. 61/662,963 filed on Jun. 22, 2012, which is herein incorporated by reference in its entirety.

### FIELD OF THE INVENTION

The invention relates to systems and methods for providing and controlling access to computing services and resources and, more particularly, to units and methods for providing unit-of-use control of computing resources including cloud-based computing services.

### BACKGROUND OF THE INVENTION

The invention relates to systems and methods for providing computing resources.

Many computing resources, such as, but not limited to, specialized programs, increased bandwidth or increased storage space are often only required by a user, that may be person or business, for a limited period of time or only at periodic intervals.

Providers of computing resources, and services that may rely on them, typically have fluctuations in demand for those resources. This fluctuation in demand may have peaks or valleys that occur at periodic times such as nightly, weekly, monthly or annually. At times of low demand, the resource providers may wish to attract more users by offering lower prices, and conversely, at times of high demand they may wish to attract users that are willing to pay a higher price.

The present invention may be implemented as a Unit-of-Use coupon, or certificate, that solves these problems and also offers third parties a convenient means of promotion.

A unit-of-use (UoU) certificate may for instance, be purchased in advance, and may provide access to a computing resource under specified limitations. These limitations may be either static or dynamic, or some combination thereof. They may, for instance, limit user access to a specific time, a specific length of time, a specific subset of functionality or any other suitable measure of computing resource.

The issuer of the UoU certificate may, for instance, pre-sell user time slots that coincide with their usual, predicted valleys of use at a significant discount to the normal price of use, thereby making money on their otherwise wasted resource. Conversely, UoU coupons guaranteeing access at peak times may be sold at a premium.

Moreover, UoU certificates may be used by third parties as, for instance, rewards or gifts that may, for instance, be part of promotional campaigns for non-computer merchandise or services. As a specific, but in no way limiting example, 5 hours use of high end editing software with every purchase of a particular digital camera.

DESCRIPTION OF THE RELATED ART

The relevant prior art includes:

US Patent Application No. 20110231280 submitted by S. Farah and published on Sep. 22, 2011 entitled “Cloud-based Desktop and Subscription Application (CDSA) Platform Apparatus, Methods and Systems” that describes a system that transforms service sign up, site creation, application registration data inputs via CDSA Platform components into new site display and Subscription App Store registration confirmation outputs. In some embodiments the CDSA Platform may facilitate generation of cloud-based desktop representations within a web browser. In one implementation, the CDSA Platform may receive a first user input, including identifying user information and a web Site address. In response to the first input, the CDSA Platform may create a new web Site at the received web Site address. In one implementation, the new website may comprise a first desktop representation on a web browser at the web Site address and may present a plurality of application icons on the first desktop representation. In a further implementation, the CDSA Platform may receive a second user input which may include an action on one of the plurality of application icons. In one implementation, in response to the second input, the CDSA Platform may present a second desktop representation on the web browser at the web Site address.

US Patent Application No. 20120040748 by K. Kanisawa et al. published on Feb. 16, 2012 entitled “Charge Payment System using Virtual Money” that describes a system where usage charge of a facility can be paid by virtual money. A card ID and a consumption amount of virtual money are transmitted from a game terminal as charging-target terminal apparatus, the card ID being recorded in a card possessed by a user. The server apparatus replaces the card ID with a user ID unique to each user, and specifies a virtual money account managed by the server apparatus in association with the user ID. When the balance of the account is not less than the consumption amount, the consumption amount is subtracted from the balance of the account, and when the balance is less than the consumption amount, the subtraction of the consumption amount is stopped. Transaction result information including information indicating whether the subtraction of consumption amount has succeeded is transmitted to the game terminal (3) as a response.

US Patent Application No. 20100070381 by M. Shea et al. published on Mar. 18, 2010 entitled “Licensing Media Consumption using Digital Currency” that describes methods and an apparatus for issuing licenses to allow end users to consume digital media content on a user device by responding to licensing requests by determining the number of digital tokens required to license the requested consumption and then issuing the license if the end user's account has a sufficient number of digital tokens.

U.S. Pat. No. 8,091,102 issued to Hon et al. on Jan. 3, 2012 entitled “Methods and systems that motivate tuning to a transmission channel for a time period” that describes systems and methods are provided for motivating a user to watch a television channel for a predetermined period of time and enabling access to a media asset related to a program provided on the channel. A tuner is tuned to a transmission channel and a program is received concurrently with a portion of a media asset. The viewing behavior is monitored to determine whether the user tunes to a different transmission channel before a predetermined time period elapses. When the user tunes to a different transmission channel before the predetermined time period elapses, access to the media asset is prevented. When the user stays tuned to the particular transmission channel for the predetermined time period, access to the media asset is enabled. The media asset may be transmitted to a portable user device, such as a mobile phone.

Various implements are known in the art, but fail to address all of the problems solved by the invention described herein. One embodiment of this invention is illustrated in the accompanying drawings and will be described in more detail herein below.

### SUMMARY OF THE INVENTION

The present invention relates to systems and methods for offering unit-of-use control of a computing resource.

In a preferred embodiment, a potential user may first obtain computing resource utilization permissions that may then be associated with them and their use of a computing resource. The computing resource utilization permissions may be either dynamic use-constraints or static use-constraints and each may, for instance, include a temporal use-constraint or a function use-constraint, or a combination thereof.

A Unit-of-Use (UoU) controller may then employ those computing resource utilization permissions in one or more unit of use utilization schemes to control access by the user to the computing resource. The unit-of-use controller may also receive utilization information from the computing resource regarding usage by the user, and may use those to update a dynamic use-constraint.

The computing resource may, for instance, include a cloud based service that may be operable on one or more cloud servers.

In a further preferred embodiment of the invention, the computing resource utilization permissions may be contained in, or be part of, an electronic Unit-of-Use (UoU) certificate. The electronic UoU certificate may, for instance, be incorporated into an email, IM or a similar message medium that may be electronically delivered via a public electronic communications network.

This delivery may be from a first, remote user's computer controlled device to a second, remote user's computer controlled device.

Therefore, the present invention succeeds in conferring the following, and others not mentioned, desirable and useful benefits and objectives.

It is an object of the present invention to provide pre-paid, access to a computing resource.

Still another object of the present invention is to provide access to a computing resource under constraints that may include an allowed time or date of access.

Still another object of the present invention is to provide access to a computing resource under constraints that may include only allowing use of a subset of the totally functionality of the computing resource.

Yet another object of the present invention is to provide access to a computing resource that may be fully, or partly, resident in the cloud.

Still another object of the present invention is to provide a method of obtaining data regarding a user's actual use of the computing resource.

### BRIEF DESCRIPTION OF THE DRAWINGS

FIG. 1 shows a system including a Unit-of-Use (UoU) controller.

FIG. 2 shows a schematic view of the interactions of a Unit-of-Use (UoU) controller in one preferred embodiment of the present invention.

FIG. 3 shows a flowchart depicting an example of a process for providing information to, and receiving information from, a cloud service provider using the UoU controller.

FIG. 4 shows a diagram illustrating an example of an interconnection model that includes a controller.

FIG. 5 shows a flowchart depicting an example of validating user parameters, and providing and receiving information from the cloud provisioning layer using the UoU controller.

### DESCRIPTION OF THE PREFERRED EMBODIMENTS

The preferred embodiments of the present invention will now be described with reference to the drawings. Identical elements in the various figures are identified with the same reference numerals.

Various embodiments of the present invention are described in detail. Such embodiments are provided by way of explanation of the present invention, which is not intended to be limited thereto. In fact, those of ordinary skill in the art may appreciate upon reading the present specification and viewing the present drawings that various modifications and variations can be made thereto.

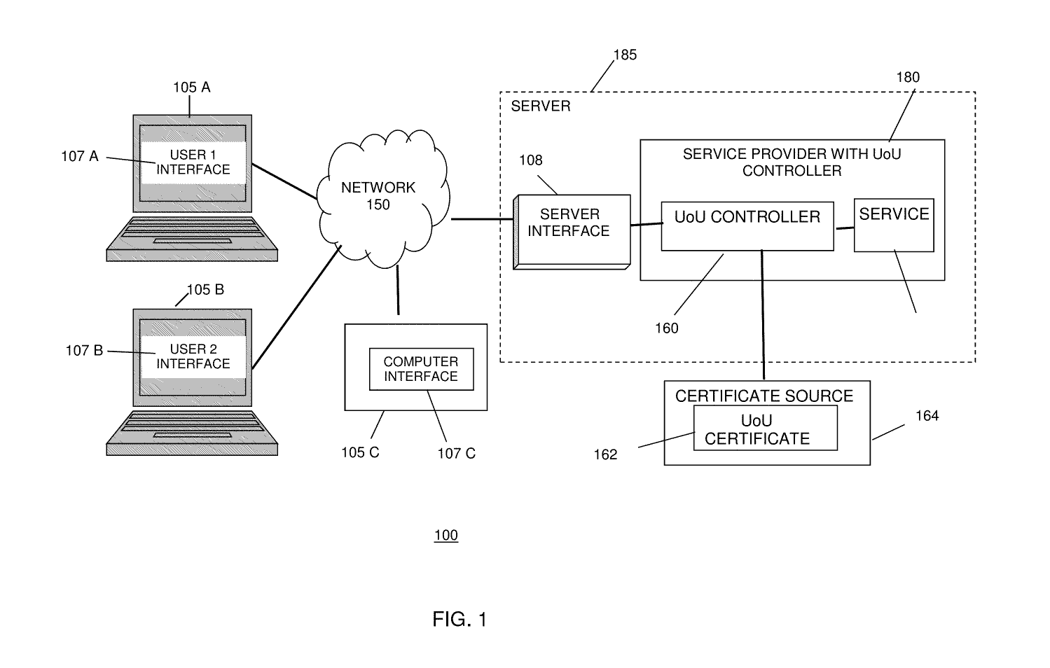

FIG. 1 depicts a system for controlling access to a service such as, but not limited to, to a cloud based service 120, by means of a unit-of-use (UoU) controller 160. The system for offering unit-of-use access 100 may include one or more computer controlled devices 105A-C, on or more user interfaces 107A-B, one or more server interfaces 108A-B, a unit-of-use (UoU) controller layer component 160, and a cloud service provider 180 all of which may be connected via a public electronic communications network 150. The computer controlled devices 105A-C may, for instance, include the user interfaces 107A-B and a server interface 108 A. The controller layer component 160 may further include, or may have access, to a UoU certificate source 164 and a server interface 108B.

The computer controlled devices 105A-C may be any suitable electronic communications or processing device such as, but not limited to, a desktop computer, a laptop computer, a tablet device, a smartphone, an e-book reader, a game playing device, or some combination thereof. The user/computer interfaces 107A-B and server interfaces 108 may, for instance, be implemented as any suitable type of interface such as, but not limited to, a touch screen menu, a mouse accessible hierarchical menu, a list or a graphic layout, or some combination thereof.

The user/computer interfaces 107A-B may, for instance, enable interaction with all appropriate aspects of the system for offering unit-of-use access 100, including, but not limited to, the UoU controller 160 and the cloud service provider 180 that may be operable on a cloud server 185. The user interfaces 107A-B may, for instance, be implemented as suitable software modules such as, but not limited to, a browser or a client application, or some combination thereof.

The server interfaces 108 may, for instance, be implemented as an application programming interface (API) that may be part of, or may have access to, the controller layer component 160 and the cloud service provider 180.

A first, remote user's computer controlled device 105 A may, for instance, access the cloud based service 120 via the UoU controller layer component 160. Such access may be determined, in part, by Unit-of-Use control of access parameters of an electronic UoU certificate 162 belonging to, or accessibly by, the first, remote user's computer controlled device 105A. The Unit-of-Use control of access parameters may include usage constraints that may, for instance, be static, dynamic or a combination thereof. A static use-constraint may, for instance, be a predetermined, unalterable usage constraint, such as, but not limited to, always only being able to access the service at a particular time of day, or always only being able to access a certain limited level of functionality of the service. A dynamic use-constraint may be a constraint that the UoU controller 160 may alter after time, or after usage of the service. A dynamic use-constraint may, for instance, include a condition such as, but not limited to, a level of functionality of the service that increases with number of usages and the user become more proficient, or it may include a condition, such as, but not limited to, changing the time of access dependent on the frequency of a user's access to the system.

As illustrated above, both static use-constraint and dynamic use-constraint may include conditions that may also, or instead, be classified as a temporal use constraint or a function use constraint, or some combination thereof.

These usage constraints of the Unit-of-Use control of access parameters may contain conditions of use such as, but not limited to, an allowed time or date of access 310, an allowed frequency of access, an allowed number of user accesses, or some combination thereof. The Unit-of-Use control of access parameters may also include pricing data such as, but not limited to, the price for use of a computer resource or operation such as, but not limited to, memory, bandwidth, a software application or access to a file, a media resource or some combination thereof. The price, or value, of an electronic UoU certificate 162 may depend on factors such as, but not limited to, the date or time period of permitted use, the number of prior or future uses, or some combination thereof.

A UoU controller layer component 160 may be used to provide selected Unit-of-Use operational parameters to the cloud service provider 180 and receive certificate utilization information from the cloud service provider 180. The UoU component layer component 160 may also include the electronic UoU certificate 162, or a copy thereof, or have access to a separate database that may include the electronic UoU certificate 162 or a copy thereof.

The electronic UoU certificate 162 may include information related to the scope and value of a Unit of Use such as, but not limited to, when and how access to the cloud based service 120 may be realized, and the cost or price related to that use. For example, the electronic UoU certificate 162 may include information associated with the use and operation of a given end-user software application such as, but not limited to, the date and time period of permitted use, the number of permitted runs or uses of the application, or some combination thereof.

In a preferred embodiment, the controller layer component 160 may provide a single interface for utilizing a cloud based resource based on the electronic UoU certificate 162. In further embodiments, the controller layer component 160, including certificate 162, may provide additional information regarding the Unit of Use parameters for the cloud service provider 180.

The cloud service provider 180 may be implemented as a service, such as for example a web service. The cloud service provider 180 may be implemented as a web site or a portal that interconnects with the UoU controller 160.

The cloud service provider 180 may provide platform resources in the form of information processors such as, but not limited to, computers, servers, blades or some combination thereof. These resources may be available, for instance, as a client server or a web service. These cloud service provider 180 resources may also have a variety of capabilities, such as, but not limited to, processing speed, memory capacity, storage capacity, and network bandwidth, i.e., bandwidth to and/or from network 150. Moreover, the cloud service provider 180 may charge a variety of associated costs that may be denominated in a number of currencies such as, but not limited to, in US dollars, Euros, yen or some combination thereof, that are charged to a user to utilize the resources at cloud service provider 180. In a preferred embodiment, the cloud service provider may interconnect with the UoU controller 160 and use information obtained in the electronic UoU certificate 162 to monitor and meter the costs and services that may be accessed by any particular user having possession of, or access to, the electronic UoU certificate 162.

In some further embodiment, the cloud service provider 180 may be located at a server facility that provides the necessary computing resources on a rental or for hire basis to the cloud service provider 180 as required.

In a preferred embodiment, network 150 may be an electronic communications network such as, but not limited to, a public electronic communications network 150. One of ordinary skill in the art will, however, appreciate that the present invention may be implemented with minimal modification on any suitable network of communications mechanisms, or otherwise directly connected devices and may include, alone or in any suitable combination, intra-process communications, the Internet, an intranet, a telephony-based network, a local area network (LAN), a wide area network (WAN), a dedicated intranet, a wireless network, and a bus or some combination thereof.

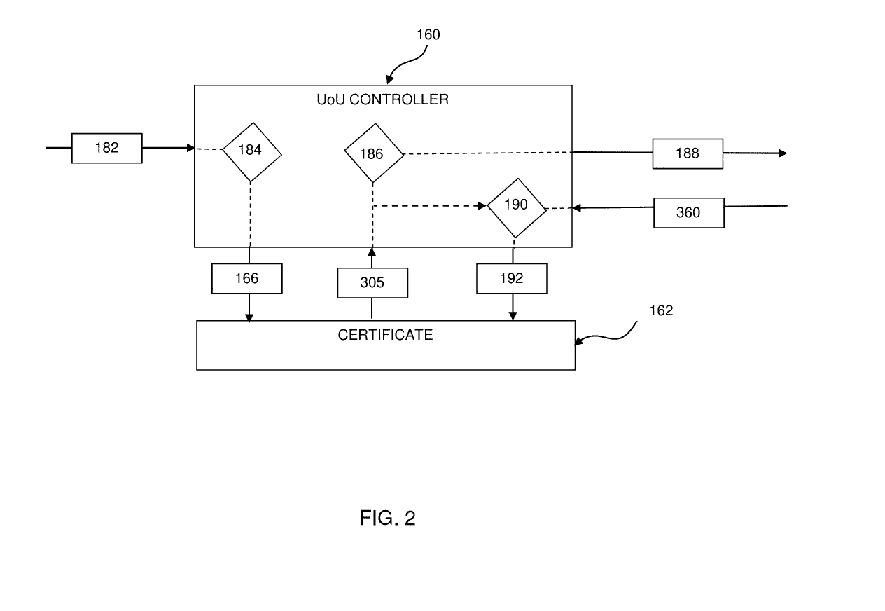

FIG. 2 shows a schematic view of the interactions of a Unit-of-Use (UoU) controller layer component in one preferred embodiment of the present invention.

In a preferred embodiment, a UoU controller 160 may receive a user identifier 182 from a potential user of a system. The user identifier 182 may, for instance, contain information such as, but not limited to, a user name, a password, a discount coupon or offer, the identity of a UoU certificate or some combination thereof.

The UoU controller layer component 160 may then use the user identifier 182 to determine access permission by a gate keeper module 184 that may, for instance, be operable on the UoU controller 160. A user name and password may, for instance, be used in a manner consistent with well know password verification in which the submitted user name and password are searched for on one or more essentially static registers, and if located and found to be matching, further processing allowed.

A UoU certificate identifier 166 may, however, be used by the UoU controller 160 to locate an electronic UoU certificate 162. The UoU certificate identifier 166 may be a module running on the UoU controller 160 or it may operate external to the UoU controller 160 as shown in FIG. 2.

The electronic UoU certificate 162 may, for instance, have computing resource utilization permissions 305 indicating a usage level of permission allowed to the user to whom the located electronic UoU certificate 162. The computing resource utilization permissions 305 may, for instance, be dynamic in the sense that they may vary dependent on a time of day, week, month or year, and/or may depend on a prior use history related to the user. The computing resource utilization permissions 305 may be passed on from the electronic UoU certificate 162 to the UoU controller 160 as illustrated, or they may be read off the certificate by the level of access allowed module 186. The computing resource utilization permissions 305 may also be passed to, or read by, the certificate change check module 190.

The UoU controller 160 may also function to supply the computing resource utilization permissions 305 both to a level of access allowed 186 module for immediate processing and to a certificate change check 190 module for later processing.

The level of access allowed 186 module may compare the computing resource utilization permissions 305 to relevant facts such as, but not limited to, the date, time, current utilization of the system or some combination thereof. The level of access allowed 186 module may then issue permissions for allowed access 188, that effectively grant the user access that is determined in part by the computing resource utilization permissions 305 and in part by current system variables or data such as, but not limited to, usage, date, time, anticipated system usage or some combination thereof.

The UoU controller 160 may receive UoU utilization parameters 360, or the certificate change check module 190 may actively obtain them from the service being used. These UoU utilization parameters 360 may be processed by the certificate change check 190 module along with any relevant computing resource utilization permissions 305 that may have been received earlier. Based on this comparison, the certificate change check 190 module may then issue a certificate change list 192 for any dynamic use-constraint that may require updating or alteration. The certificate change list 192 may, for instance, contain one or more updates to the computing resource utilization permissions 305 that may be recorded on the electronic UoU certificate 162 in anticipation of future attempts by the user to obtain access to the system by means of the UoU controller layer component 160 and an associated electronic UoU certificate 162.

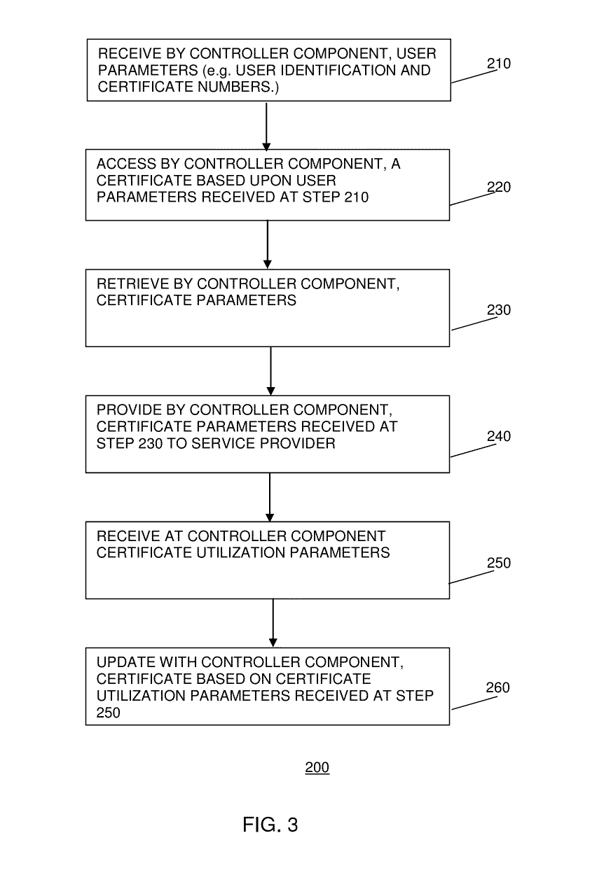

FIG. 3 shows a flowchart depicting an example of a process 200 for providing information to, and receiving information from, a cloud service provider using the UoU controller layer component.

In a preferred embodiment, the UoU controller layer component 160 may determine the certificate parameters based upon user parameters such as, but not limited to, a user identification number and certificate numbers, to provide the unit-of-use control of access parameters to the cloud service provider. The UoU controller 160 may also, for instance, receive certificate utilization parameters from the cloud based service 120 and update utilization parameters on, or for, the related electronic UoU certificate 162.

At step 210, the UoU controller layer component 160 may receive UoU user parameters 345 from the user interfaces 107A-B, or from server interfaces 108A-B. For example, the controller layer component 160 may receive information from user interfaces 107A-B indicating a user identification and one or more certificate numbers of electronic UoU certificate 162 controlled by the identified user.

At step 220, based in part upon the user identification parameters and certificate numbers received in step 210, the UoU controller layer component 160 may access an electronic UoU certificate 162 that may, for instance, be stored at a UoU certificate source 164, or on a cloud server 185.

At step 230, the UoU controller layer component 160 may retrieve one or more unit-of-use control of access parameters form the electronic UoU certificate 162. The unit-of-use control of access parameters may, for instance, indicate the date and time period for which use of the cloud based service 120 is permitted, how many uses of it are permitted and the charges for, or the value of, the unit of use.

At step 240, the UoU controller layer component 160 may provide the UoU control of access parameters that may have been obtained from the electronic UoU certificate 162 to the cloud service provider 180.

At step 250 the UoU controller layer component 160 may receive UoU utilization parameters 360 from the cloud service provider 180. For example, the UoU controller layer component 160 may receive information from the cloud service provider 180 such as, but not limited to, data indicating when and/or how the electronic UoU certificate 162 was used, such as, a date and time of day the certificate was used, the duration of use, the type of use, the services used, or some combination thereof.

At step 260 the UoU controller layer component 160 may access and update electronic the UoU certificate 162 using one or more of the UoU utilization parameters 360 that may have been received during step 250. The UoU controller layer component 160 may record or encode some or all of the information received from the cloud service provider 180 on or in the electronic UoU certificate 162. This may include items such as, but not limited to, data indicating when and/or how the electronic UoU certificate 162 was used, such as, a date and time of day the certificate was used, the duration of use, the type of use, the services used, or some combination thereof.

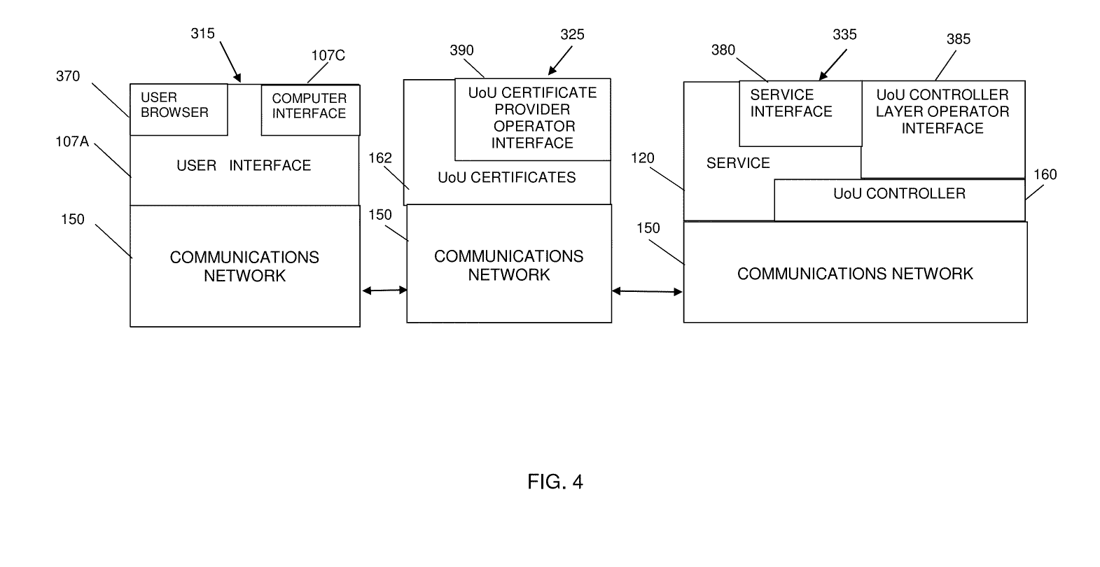

FIG. 4 uses a simplified Open Systems Interconnection (OSI) type model to depict some of the relevant interconnections that occur in and between a user platform 315, a certificate provider platform 325 and a cloud service provider platform 335.

The user platform user platform 315, the certificate provider platform 325 and the cloud service provider platform 335 may, for instance only communicate at the network layer (OSI layer 3) with the information in the form of packets carried on the data link (OSI layer 2) and the physical layers (OSI layer 1), both of which may form part of the network.

In the user platform 315 the user interface 107A may encompass OSI layers 5-7, i.e., the session, presentation and application layers, while user browser 370 and the computer interfaces 107 C may encompass OSI layers 6&7, the presentation and application layers.

In the certificate provider platform 325, the electronic UoU certificates 162 and the software used to create and monitor them may encompass OSI layers 5-7, while certificate provider platform 325 may encompass OSI layers 6-7.

In the cloud service provider platform 335, the cloud service operator interface 380 may encompass OSI layers 5-7, while the public electronic communications network 150 resides primarily in OSI layer 5, the UoU controller layer operator interface 385 in layers 6 and 7 and the cloud service operator interface 380 may reside primarily in OSI layer 7 as an application.

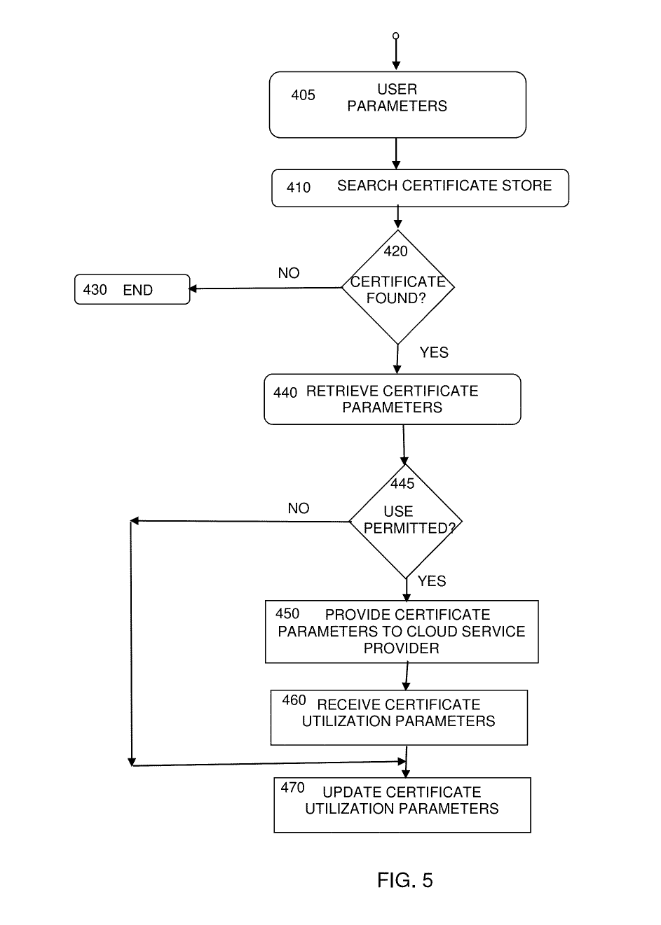

FIG. 5 depicts an example of a process to allow the use of the User Parameters to search for the corresponding Certificate to validate it, to retrieve the certificate parameters, provide the certificate parameters to the Cloud Service, and receive and Update the certificate with utilization information. The Certificate 162 defines the parameters of the Unit-of-Use of the Cloud Service. For example, the certificate 162 may specify that a single use of an application may be one run of it and the price for the use. The Controller component layer 160 may thus Control the use of the Cloud Service based on the certificate 162.

At step 405 the UoU controller layer component 160 may, for instance, be receive one or more sets of UoU user parameters 345 from user interfaces 107A-B. For example, the UoU controller layer component 160 may receive information from the user interfaces 107A-B indicating UoU user identification and electronic UoU certificate 162 numbers and/or codes.

At step 410, the UoU controller layer component 160 may access the UoU certificate source 164 and may attempt to locate a particular electronic UoU certificate 162 based upon the user parameters received at 210 from user interfaces 107A-B.

At step 420 the electronic UoU certificate 162 may be located and validated. For example the UoU certificate source 164 may be searched using the UoU user identification and the certificate number. If a match is found and the electronic UoU certificate 162 the related UoU utilization parameters 360 may be retrieved. The one or more UoU utilization parameters 360 also be subject to an initial check at this stage in which data such as, but not limited to, the current date and time may be used to check if the UoU utilization parameters 360 are within the date and time permitted by the electronic UoU certificate 162.

The required electronic UoU certificate 162 may not found in the electronic UoU certificate 162, in which circumstance the process may be terminated and exited via step 430.

At step 440, the UoU controller layer component 160 may receive the UoU utilization parameters 360 obtained in step 420. For example, the UoU controller layer component 160 may receive information from the UoU certificate source 164 regarding a certificate user indicating when the use is permitted. This information may, for instance, include the date and time period the use is permitted and the charge that may be incurred for the use.

At step 445 the UoU utilization parameters 360 may be further checked to ascertain if system use is permitted. If system use is not permitted, the operation may proceed to step 470 and proceed as detailed below.

If use is permitted, then the system may proceed to step 450 and operate as described below.

At step 450 the UoU controller layer component 160 may provide UoU utilization parameters 360 obtained from the electronic UoU certificate 162 to the cloud server 185 that may be hosting the cloud based service 120 for the UoU user.

At step 460 the UoU controller layer component 160 may receive one or more UoU utilization parameters 360 from the cloud server 185 that may be hosting the cloud based service 120. For example, the UoU controller layer component 160 may receive information from the cloud server 185 indicating when the certificate use occurred such as, but not limited to, the date and time the certificate was used.

At step 470 the UoU controller layer component 160 may access and update the electronic UoU certificate 162 using one or more of the UoU utilization parameters 360 that may have been received at step 250. For example, the UoU controller layer component 160 may receive information from the cloud server 185 indicating when the certificate use occurred such as, but not limited to, the date and time the certificate was used.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A method for offering unit-of-use control of a computing resource, comprising:
obtaining computing resource utilization permissions associated with a user of a computing resource;
controlling said user's access to said computing resource using a unit-of-use controller and said computing resource utilization permissions; and
receiving utilization information from said computing resource regarding usage by said user.

2. The method for offering unit-of use control of claim 1 wherein said computing resource comprises a cloud based service operable on one or more cloud servers.

3. The method for offering unit-of use control of claim 1 further comprises an electronic UoU certificate comprising said computing resource utilization permissions associated with said user.

4. The method for offering unit-of use control of claim 3 wherein said electronic UoU certificate associated with said user is electronically available via an electronic communications network to a first, remote user's computer controlled device from a second, remote user's computer controlled device.

5. The method for offering unit-of use control of claim 4 wherein said computing resource utilization permissions further comprise a static use-constraint or a dynamic use-constraint.

6. The method for offering unit-of use control of claim 4 wherein said computing resource utilization permissions further comprise both a dynamic use-constraint and a static use-constraint.

7. The method for offering unit-of use control of claim 6 wherein said dynamic use-constraint and said static use-constraint both further comprise a temporal use constraint and a function use constraint, and wherein said temporal use constraint comprises a specified time of day during which access is allowed, and wherein said function use constraint comprises a subset of said cloud based service functions to which access is allowed.

8. The method for offering unit-of use control of claim 4 wherein said computing resource utilization permissions comprise at least one usage constraint selected from the group consisting of an allowed time access, an allowed date of access, an allowed frequency of access and an allowed number of user accesses, or some combination thereof.

9. The method for offering unit-of use control of claim 3 wherein receiving utilization information from said computing resource regarding usage by said user further comprises usage data indicating when said electronic UoU certificate was used.

10. The method for offering unit-of use control of claim 9 wherein said usage data further comprises a date and time of day the certificate was used and the duration of use.

11. The method for offering unit-of use control of claim 9 wherein said usage data further comprises a type of use and a service used.

12. The method for offering unit-of use control of claim 9 further comprising said Unit-of-Use controller updating a dynamic use-constraint of said electronic Unit-of-Use certificate.
